(19) United States
(12) Patent Application Publication
(10) Pub. No.: US 2004/0217873 A1
(43) Pub. Date: Nov. 4, 2004

(54) Tool wear and/or breakage control device for a machine tool

(75) Inventors: Alain Schweitzer, Lyon (FR); Pascale Perrin, Saint Marcellin en Forez (FR)

Correspondence Address: HESLIN ROTHENBERG FARLEY & MESITI PC, 5 COLUMBIA CIRCLE, ALBANY, NY, 12203, US

(73) Assignee: Digital Way, Saint Etienne (FR)

(21) Appl. No.: 10/773,495

(22) Filed: Feb. 6, 2004

Related U.S. Application Data
(63) Continuation of application No. PCT/FR02/02807, filed on Aug. 6, 2002.

(30) Foreign Application Priority Data
Aug. 7, 2001 (FR) 0110670

(51) Int. Cl. G08B 21/00

(52) U.S. Cl. 340/680

(57) ABSTRACT

A tool wear and/or breakage control device for a machine tool includes, in one single unit, through which the three motor supply phases pass completely, all of the components required to measure the active power and/or the active currents absorbed by the motor, and digital means for detecting tool wear and/or breakage in comparison to a reference curve which is established during a first machining operation performed by the tool.

The invention pertains to the technical sector of means for measuring the parameters of a three-phase network, in particular the voltage, the current, the phase shift and the frequency, its aim being to calculate the characteristic physical quantities, such as the active power, the energy, the electric torque, the active currents, the reactive currents, etc.

It has in particular been found to be important to be able to measure these various parameters, in an independent manner, so as to calculate accordingly the formula one wants in combination with appropriate software or the like.

An advantageous solution suitable for solving this problem emerges from the teaching of patent FR 2,531,077 which relates to a device for measuring the parameters of a three-phase network essentially comprising means suitable for measuring the current on at least one of the phases of the network and means suitable for measuring the voltages compounded so as to recreate an artificial neutral in order to obtain the three simple voltages.

This measuring device finds a particularly advantageous application in respect of the monitoring of the wear and/or breakage of a tool of a machine tool with a synchronous or asynchronous three-phase motor in particular. This device uses the measurement of the power and the energy absorbed by the motor for driving the tool-holder spindle in order to ascertain the state of said tools. Specifically, it is apparent, that when two machining operations for example are carried out under the same conditions with identical tools, the energy absorbed is the same. On the other hand, wearing of the tools generates an increase in the energy. During a learning cycle, the instantaneous power is stored in memory by the device. During work cycles, the device measures and calculates in real time the power and the energy, and compares them with those absorbed during the learning phase. If the power or the energy absorbed in a work cycle is greater than the power or the energy stored in memory, with a specified coefficient, this signifies that the device detects tool wear or breakage.

According to the prior art, this tool wear and breakage monitoring device is independent of the other elements or modules necessary for the command and control of the motor and for the measurement of certain electrical parameters.

For example, in the embodiment illustrated in FIG. 1, the motor (M) is connected to the three-phase network (R) by way of a module (A) exhibiting, in a manner perfectly well known to the person skilled in the art, any control system such as a variable-speed drive, frequency converter, etc. This control module is itself subject to a digital command module (B) or other command facility such as an automatic controller via an analogue link or a digital bus (a). At the output of the module (A), the three phases of the network are connected to a system (CA), sensor of electrical measurements (power, current, etc.). The electrical measurements sensor (CA), via an analog link or a digital bus (b), is linked to the tool wear and breakage monitoring device as such (D). The module (D) is linked to the command module (B) by a wire link or a fieldbus (c).

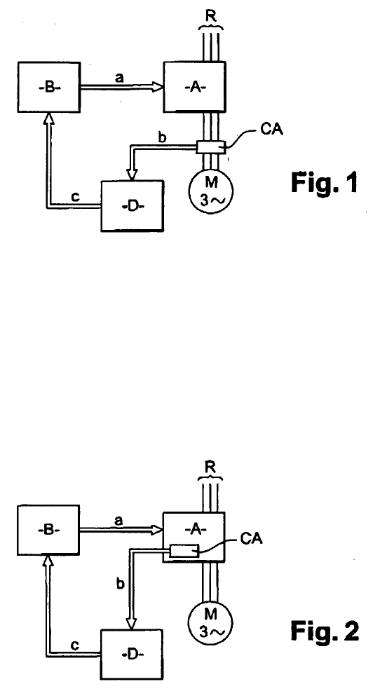

In FIG. 2, which shows another embodiment according to the prior state of the art, the electrical measurement sensor (CA) is no longer isolated, but integrated with the motor control module. On the other hand, the module (D) relating to the tool breakage and monitoring device, is still independent.

Patent EP 0969340 proposes that the detection of the critical state of a tool be carried out without any learning curve or calibration curve being necessary for operation. For this purpose, the difference is measured between the mean of the current calculated over the last few instants (dynamic preset value) and the instantaneous value of the current. This difference thus established is then compared with a fixed value (preset value) to detect the critical state.

Starting from this state of the art, the problems that the invention proposes to solve are to simplify the installation and the wiring, to reduce the necessary bulkiness of a tool wear and/or breakage monitoring system in the electrical cabinet, and to do away with the drawbacks related to the transmission of the measurements between the sensor and the monitoring device. Under these conditions, it is possible to increase the reliability, the speed and the precision of the assembly consisting of an automatic controller, a tool wear and breakage monitor and an electrical measurement system, while allowing the automatic command controller to be plugged directly into the single system: electrical measurement and tool wear and/or breakage monitor.

To solve such problems, a device for monitoring tool wear and breakage for a machine tool has been designed and fine-tuned, exhibiting a command module and a control system for the tool drive motor, said device comprising, in a single module through which the three supply phases for the motor pass fully, all the necessary components suitable for measuring the active power and/or the active currents absorbed by the motor.

According to the invention, the device integrates means for digital monitoring of tool wear, absence and breakage simultaneously using the power, the energy (integral of the power) and the derivative of the power to detect any defect (tool fracture, tool absence, poor workpiece positioning or machine defect) in any type of machining operation, in particular in machining operations with several tools on one and the same motor, turning and usage on rough workpieces, by comparison with a reference curve established during a first machining operation performed by the tool.

These characteristics enable the detection of all cases of tool wear, breakage or absence.

In view of the integration of the measurement of the electrical quantities, and of the tool wear and breakage monitoring, it is important that the presence of the power signals at the measurement level do not disturb the remainder, so as to limit any risk of malfunction liable to result from such compactness.

To solve such a problem, the electrical measurements module and the means of digital monitoring of the tool wear and breakage are galvanically and/or electromagnetically isolated.

Starting from the basic concept of the invention, which is to be able to integrate various functions to the maximum:

either the control system for the tool drive motor and the module for electrical measurement and for monitoring the tool wear and breakage are integrated into one and the same assembly;

or the command module and the module for electrical measurement and for monitoring the tool wear and breakage are integrated into one and the same assembly;

or the command module, the control system for the tool drive motor and the module for electrical measurement and for monitoring the tool wear and breakage are integrated into one and the same assembly.

The invention is set forth below in greater detail with the aid of the appended figures in which:

FIG. 1 is a schematic showing the command, the monitoring and the measurement of the electrical quantities of a motor according to the prior state of the art;

FIG. 2 is a view similar to FIG. 1 showing another solution according to the prior state of the art;

FIG. 3 is a schematic showing the command, the monitoring and the measurement of certain electrical quantities of a motor according to a characteristic underlying the device of the invention.

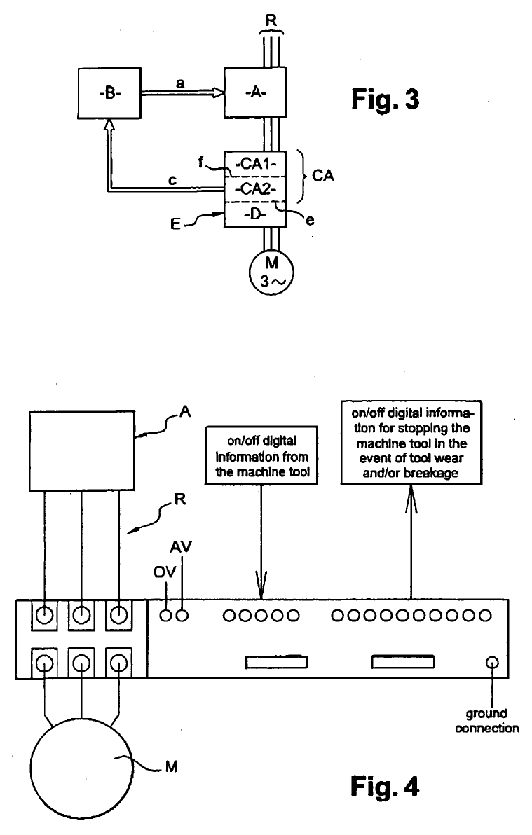

FIG. 4 shows more particularly the single module suitable for detecting the wear and/or the breakage of tools of a machine tool spindle for example.

As shown in FIG. 1, the device according to the invention comprises a module (A) constituting the control system for the motor (M), integrating for example a variable-speed drive, a frequency converter, etc. The motor (M) constitutes for example the drive motor for a machine tool spindle.

As indicated, in a known manner, this module (A) is subject to the digital command module (B) or other command system such as a programmable automatic controller. The link between the modules (A) and (B) is effected by a digital bus or an analog link (a).

According to the invention, at the output of the module (A), the three-phase supply network (R) for the motor (M) is intercepted by a module (E) integrating a means of measurement of the electrical quantities (CA) (power, current, etc.) and a digital means of monitoring the tool wear and breakage (D) by comparison with a learning power curve established during a first operation performed by a tool under the command of the motor (M).

The module (E) is linked to the command module (B) by a fieldbus or a wire link (c).

This therefore results in integration in the module (E) of the functions of measurement of the electrical quantities and of the digital monitoring of tool wear and breakage.

In view of this integration, it has been necessary to solve the problem of how to prevent the presence of the three-phase power signals for controlling the motor from disturbing the monitoring function. For this purpose, the system (CA) suitable for performing the measurements and for digitizing them has been designed in two parts (CA1) and (CA2) mutually -galvanically isolated (g).

The acquisition (CA1) of the analog quantities of currents and voltages, by appropriate devices such as for example shunts for the currents and resistor bridges for the voltages.

The amplification, the shaping and the digitization (CA2) of the signals with a view to their utilization for the monitoring of tool wear and breakage.

Since the digitized electrical signals are galavanically isolated from the three-phase power network, the only disturbances that may be received by the digital monitoring of tool wear and breakage (D) are of electromagnetic origin and created by the strong variations in current that may appear during the control of the motor.

To obviate this, two methods have been set in place:

an electromagnetic screen (c) has been inserted between the measurement module (CA) and the monitoring (D);

the use of a microcontroller instead of a microprocessor immunizes the system to electromagnetic disturbances. This is thanks to the integration of the processor, of the program memory and of the user stack into one and the same electronic component.

Starting from this basic concept, the modules (A) and (E) can be integrated into one and the same assembly. The same holds as regards the modules (B) and (E) which may be integrated into one and the same assembly. Finally, according to another embodiment, for total integration, the modules (A), (B) and (E) are integrated into one and the same assembly.

The elimination of any element between the measurement and processing part (such as computer network, wire link, etc.) increases the quality of the measurements of power and/or of current (higher sampling rate, elimination of transmission glitches, etc.). Benefiting from this advantage, it is then possible to utilize another physical quantity: the derivative of the power and/or of the current.

Hitherto, the tool wear and breakage monitoring checks have detected tool wear and absence by measuring the energy, tool fracture and absence by measuring power.

However, the supervision of tools fitted with tips (milling cutter, boring tool) or of multi-tool heads (10 drills driven by the same motor) using only energy and power is not reliable enough to detect the fracture of a tip or of a tool.

The simultaneous combination of monitoring via the power, the energy and the derivative appreciably improves the detection of tool wear and/or breakage.

The advantage of the derivative stands out in the case of boring with complex tool, drilling and tapping with multi-tool head, these being some operations where the fracture of a tool causes only a small variation in the power. This advantage stands out also in the case of milling and turning on rough workpieces, for which the amplitude of the power absorbed varies greatly from one workpiece to another. The derived monitoring used amplifies the small fast variations in power (fracture of a single tip on a milling cutter, fracture of one tool on a multi-tool head, etc.) and eliminates the variations due to differences in rough stock. The derivative thus allows reliable detection of the fracture of tools or of tips in these machining operations.

On the other hand, the use of the derivative with just one of the other two monitoring checks (power or energy) is not sufficient to detect all cases of wear, breakage or absence. It is only the combining of the three monitoring checks simultaneously that ensures the reliability of detections.

The advantages emerge clearly from the description.

1. A device for monitoring tool wear and/or breakage for a machine tool, having a command module and a control system for a tool drive motor, said device comprising, in a single module through which three supply phases for the motor pass fully, all the necessary components for electrical measurement of active power and/or active currents absorbed by the motor, and integral means for digital monitoring of tool wear, absence and breakage simultaneously using the power, an integral of the power and a derivative of the power to detect a defect in a type of machining operation, by comparison with a reference curve established during a first machining operation performed by the tool.

2. The device as claimed in claim 1, wherein in the single module, electrical measurements and the means for monitoring the tool wear and breakage are galvanically and/or electromagnetically isolated.

3. The device as claimed in claim 1, wherein the control system for the tool drive motor and the module for electrical measurement and for monitoring of tool wear, absence and breakage are integrated into one and the same assembly.

4. The device as claimed in claim 1, wherein the command module and the module for electrical measurement and for monitoring of tool wear, absence and breakage are integrated into one and the same assembly.

5. The device as claimed in claim 1, wherein the command module, the control system for the tool drive motor and the module for electrical measurement and for monitoring of tool wear, absence and breakage are integrated into one and the same assembly.

6. The device as claimed in claim 1, wherein said defect comprises at least one of: tool fracture, tool absence, poor workpiece positioning and machine defect.

7. The device as claimed in claim 1, wherein said type of machining operation comprises at least one of: a machining operation with several tools on one and the same motor, and turning and usage on rough workpieces.
